(19) United States
(12) Patent Application Publication
(10) Pub. No.: US 2010/0234210 A1
(43) Pub. Date: Sep. 16, 2010

(54) Fuel Cell Electrode Catalyst Comprising Binary Platinum Alloy and Fuel Cell Using the Same

(76) Inventors: Tetsuo Kawamura, South Windsor, CT (US); Hiroaki Takahashi, Aichi (JP); Susumu Enomoto, Shizuoka (JP); Tomoaki Terada, Shizuoka (JP); Takahiro Nagata, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/294,897

(22) PCT Filed: Mar. 27, 2007
(86) PCT No.: PCT/JP2007/057356

§ 371 Date: Sep. 26, 2008

(30) Foreign Application Priority Data
Mar. 31, 2006 (JP) 2006-099013

(51) Int. Cl. H01M 4/88; B01J 21/18; B01J 23/42

(52) U.S. Cl. 502/101; 502/185

(57) ABSTRACT

An object of the present invention is to provide a fuel cell electrode catalyst which offers an improved durability while inhibiting the degradation of an initial catalytic activity to exhibit a stably high catalytic activity over a long period. The present invention provides a fuel cell electrode catalyst having an alloy carried by carbon, the alloy consisting of platinum and a platinum-family metal other tha platinum, characterized in that a composition ratio of platinum to platinum-family metal other than platinum to carbon is 1:(0.03 to 1.5):(0.46 to 2.2) (wt ratio).

### TECHNICAL FIELD

The present invention relates to a fuel cell electrode catalyst exhibiting an initial activity and a high durability, and a fuel cell having this electrode catalyst.

### BACKGROUND ART

Fuel cells have been drawing much attention as clean generation systems; products resulting from cell reactions are in principle water, which exerts few adverse effects on global environments. For example, solid polymer fuel cells have a proton-conductive solid polymer electrolyte membrane and a pair of electrodes provided on the respective surfaces of the solid polymer electrolyte membrane. One of the electrodes (fuel electrode: anode) is supplied with hydrogen gas as a fuel gas, while the other electrode (air electrode: cathode) is supplied with oxygen gas or air as an oxidizer. Thus, an electromotive force is obtained.

The cell characteristics of solid polymer fuel cells have been drastically improved for the following reasons. (1) Polymer electrolyte membranes having high ion conductivities have been developed. (2) What is called a reaction site in a catalyst layer has been made three-dimensional by using, as a component of an electrode catalyst layer, catalyst carrying carbon coated with the same ion exchange resin (polymer electrolyte) as or an ion exchange resin (polymer electrolyte) different from that contained in the polymer electrolyte membrane. In addition to having the improved cell characteristics, the solid polymer fuel cell allows its size to be easily reduced. The solid polymer fuel cell is thus expected to be used for mobile vehicles such as electric cars or as power sources for small cogeneration systems.

A gas diffusing electrode used for the solid polymer fuel cell normally comprises a catalyst layer containing catalyst carrying carbon coated with the ion exchange resin and a gas diffusion layer which supplies reaction gas to the catalyst layer and which collects current. The catalyst layer has voids comprising very small pores formed among secondary or tertiary particles of carbon, which is a component of the catalyst layer. The voids function as diffusion paths for reaction gas. The catalyst is normally a noble metal such as platinum or a platinum alloy which is stable in an ion exchange resin.

The cathode and anode catalysts, the electrode catalysts of the polymer electrolyte fuel cell, each comprise a noble metal such as platinum or a platinum alloy which is carried by carbon black. The platinum carrying carbon black is generally prepared by adding sodium bisulfite to a water solution of platinum chloride, allowing the mixture to react with hydrogen peroxide so that carbon black can carry the resulting platinum colloids, and washing and thermally treating the mixture as required. The electrodes of the polymer electrolyte fuel cell are each produced by dispersing the platinum carrying carbon black in a polymer electrolyte solution to prepare ink and coating and drying the ink on a gas diffusion substrate such as carbon paper. The two electrodes obtained are arranged so as to sandwich the polymer electrolyte membrane between them. The electrodes are hot-pressed to form an electrolyte membrane-electrode assembly (MEA).

Platinum is an expensive noble metal and is desired to exhibit sufficient performance even when a small amount of platinum is carried by carbon black. Much effort has thus been made to allow a small amount of platinum to exhibit an enhanced catalyst activity. For example, JP Patent Publication (Kokai) No. 2003-77481 A discloses an invention using the X-ray diffraction measurement of a catalytic substance on the surface of an electrode as a parameter and according to which the measurement within a particular range results in an enhanced catalytic activity, enabling a reduction in the amount of catalytic substance used than the amount used in a conventional method. This invention sets the ratio (I(111)/II(200)) of the peak intensity I of the (111) surface of catalytic metal particulates to the peak intensity II of their (200) surface based on X-ray diffraction, to at most 1.7.

To provide a fuel cell electrode catalyst which suppresses the growth of platinum particles during operation and which exhibits high durability performance, JP Patent Publication (Kokai) No. 2002-289208 A discloses an electrode catalyst consisting of a conductive carbon material, metal particles carried by the conductive carbon material and which is more unlikely to be oxidized than platinum under acid conditions, and platinum covering the outer surface of the metal particles. Specifically, JP Patent Publication (Kokai) No. 2002-289208 A illustrates an allow consisting of platinum and metal particles of at least one type of metal selected from the group consisting of gold, chromium, iron, nickel, cobalt, titanium, vanadium, copper, and manganese.

For the solid polymer fuel cell, hydrogen containing gas (fuel gas) is used as anode reaction gas. Oxygen containing gas, for example, air, is used as cathode reaction gas. In this case, an electrode reaction shown in Formula (1) occurs in the anode. An electrode reaction shown in Formula (2) occurs in the cathode. As a whole, a total cell reaction shown in Formula (3) occurs to generate an electromotive force.

H₂→2H⁺+2e⁻ (1)

(½)O₂+2H⁺+2e⁻→H₂O (2)

H₂+(½)O₂→H₂O (3)

However, in the conventional solid polymer fuel cell, an activation overpotential resulting from an oxygen reducing reaction shown in Formula (2) is much higher than that resulting from a hydrogen oxidizing reaction shown in Formula (1). This unfortunately prevents the provision of high cell power.

Moreover, to offer an excellent cathode polarization characteristic and high cell power, JP Patent Publication (Kokai) No. 2002-15744 A discloses a cathode having a catalyst layer containing a metal catalyst selected from the group consisting of platinum and platinum alloys and a metal complex having a predetermined amount of iron or chromium in order to improve the polarization characteristic of the cathode. Specifically, this invention provides a solid polymer fuel cell comprising an anode, a cathode, and a polymer electrolyte membrane located between the anode and the cathode. The solid polymer fuel cell is characterized as follows. The cathode comprises a gas diffusion layer and a catalyst layer located between the gas diffusion layer and the polymer electrolyte membrane. The catalyst layer contains a noble metal catalyst selected from the group consisting of platinum and platinum alloys and a metal complex having a predetermined amount of iron or chromium. The amount of metal complex contained in the catalyst layer is equal to 1 to 40 mole percents of combined amount of the metal complex and noble metal catalyst. The metal complex thus contained in the catalyst layer of the cathode and having iron or chromium enables an effective reduction in the activation overpotential resulting from the oxygen reducing reaction of the cathode, shown in Formula (2). This improves the polarization characteristic of the cathode to provide high cell power.

The electrolyte membrane should allow only protons to migrate through itself across its thickness. However, a trace amount of hydrogen or oxygen may migrate through the membrane across the membrane thickness; a trace amount of hydrogen may migrate from the fuel electrode (anode) toward the air electrode (cathode), or a trace amount of air may migrate from the air electrode (cathode) toward the fuel electrode (anode) (this is called cross leak).

Thus, what is called a cross leak problem may occur in the solid polymer fuel cell. That is, each of the gases supplied to the respective electrodes may partly diffuse through the electrolyte without contributing to an electrochemical reaction and mix, at the opposite electrode, with the gas supplied to that electrode. The cross leak may lower cell voltage and energy efficiency. Moreover, a burning reaction resulting from the cross leak may create holes in a polymer membrane corresponding to the electrolyte. This may prevent the operation of the cell.

On the other hand, to reduce the internal resistance of the cell to increase power, attempts have been made to reduce the thickness of the polymer membrane corresponding to the electrolyte. However, a thinner polymer membrane allows the gas to diffuse more easily therethrough, making the cross leak problem more serious. The thinner polymer membrane also has a reduced mechanical strength and allows pin holes or the like to be readily created therein during the manufacture of a polymer membrane. These defects in the polymer membrane itself are also a factor increasing the possibility of cross leak.

### DISCLOSURE OF THE INVENTION

Attempts have been made to utilize electrode catalysts and fuel cells using the electrode catalysts, particularly solid polymer fuel cells, as stationary power sources or power sources for automobiles. Improving cell performance is important, but maintaining a desired generation performance over a long period has been strongly desired. Further, this demand is particularly strong owing to the use of the expensive noble metal. In particular, since an oxygen reducing electrode provides a high oxygen reducing overpotential, in a high potential environment, melting or re-precipitation of platinum is the major cause of reduced efficiency of the fuel cell.

However, JP Patent Publication (Kokai) No. 2003-77481 A is only intended to enhance the catalytic activity and makes no evaluations on the durability of the catalyst or the like.

The use of a noble metal-base metal alloy containing catalyst as in the invention described in JP Patent Publication (Kokai) No. 2002-289208 A may disadvantageously cause the elution of the base metal such as iron, which is the pairing material of the noble metal such as platinum, during the use of the fuel cell. This results in impurities (contamination) in the electrolyte, degrading the durability performance of the fuel cell.

Similarly, the use of a metal complex containing iron or chromium as a promoter as in the invention described in JP Patent Publication (Kokai) No. 2002-15744 A initially provides high cell power but may disadvantageously cause the elution of iron or chromium during the use of the fuel cell. This results in impurities (contamination) in the electrolyte, degrading the durability performance of the fuel cell.

Thus, the conventional electrode catalysts are inferior in either initial performance or durability; it has been difficult to provide an electrode catalyst that is excellent in both initial performance and durability.

Thus, an object of the present invention is to provide a fuel cell electrode catalyst which offers an improved durability while inhibiting the degradation of the initial catalytic activity to exhibit a stably high catalytic activity over a long period.

The present inventors have made the present invention by finding that the use of an alloy of a particular platinum-family metal element having a particular composition range achieves the above object to provide a durable fuel cell electrode catalyst exhibiting an appropriate initial activity.

First, the present invention provides a fuel cell electrode catalyst having an alloy carried by carbon, the alloy consisting of platinum and a platinum-family metal other than platinum, wherein a composition ratio of platinum to platinum-family metal other than platinum to carbon is 1:(0.03 to 1.5):(0.46 to 2.2) (wt ratio). Examples of the platinum-family metal other than platinum include iridium (Ir), rhodium (Rh), gold (Au), and palladium (Pd). These optimizing ratios enhance the initial performance, inhibit a decrease in cell voltage as well as cross leak, and improve the durability of the fuel cell.

The composition ratio of the platinum-family metal other than platinum to platinum out of the range from 0.03 to 1.5 results in a decrease in cell voltage after endurance and an increase in the amount of cross leak. The composition ratio of carbon to platinum out of the range from 0.46 to 2.2 reduces the initial cell voltage.

When the platinum-family metal other than platinum is iridium (Ir), the composition ratio of platinum to iridium to carbon is preferably 1:(0.08 to 1.5):(0.46 to 2.2) (wt ratio), more preferably 1:(0.17 to 1.0):(0.86 to 1.88) (wt ratio). The composition ratio of platinum to iridium to carbon within this range allows the platinum and iridium to be alloyed, with the alloy carried by the carbon. This inhibits the elution of the catalyst metal to optimize the effect of improving durability.

When the platinum-family metal other than platinum is iridium (Ir), a platinum (111) surface preferably has a lattice constant of 3.875 to 3.916 Å as calculated from X ray diffraction results. This preferably increases the solid solubility based on the alloying of the platinum and iridium.

When the platinum-family metal other than platinum is rhodium (Rh), the composition ratio of platinum to rhodium to carbon is preferably 1:(0.03 to 1.5):(0.46 to 2.2) (wt ratio).

When the platinum-family metal other than platinum is gold (Au), the composition ratio of platinum to gold to carbon is preferably 1:(0.03 to 1.5):(0.46 to 2.2) (wt ratio).

In the fuel cell electrode catalyst in accordance with the present invention, the platinum and the alloy consisting of the platinum-family metal other than platinum preferably have an average particle size of 3 to 20 nm, more preferably 3 to 15 nm.

Second, the present invention provides a method for manufacturing a fuel cell electrode catalyst having an alloy carried by carbon, the alloy consisting of platinum and a platinum-family metal other than platinum, wherein a composition ratio of platinum to platinum-family metal other than platinum to carbon is 1:(0.03 to 1.5):(0.46 to 2.2) (wt ratio), the method comprising a step of adding a salt of platinum-family metal other than platinum to a water dispersion of carbon, a step of converting the palatinate and the salt of platinum-family metal other than platinum into hydroxides in an alkali atmosphere, a step of reducing the hydroxide of the platinum and the hydroxide of the platinum-family metal other than platinum, and a step of alloying the reduced platinum and the reduced platinum-family metal other than platinum.

In the method for manufacturing a fuel cell electrode catalyst in accordance with the present invention, when the platinum-family metal other than platinum is iridium (Ir), the optimum range of composition ratio of platinum to iridium to carbon is as described above, and a platinum (111) surface preferably has a lattice constant of 3.875 to 3.916 Å as calculated from X ray diffraction results as described above. When the platinum-family metal other than platinum is rhodium (Rh), the optimum range of composition ratio of platinum to rhodium to carbon is as described above. When the platinum-family metal other than platinum is gold (Au), the optimum range of composition ratio of platinum to gold to carbon is as described above. The alloy consisting of the platinum and the platinum-family metal other than platinum preferably have an average particle size of 3 to 20 nm as described above.

Third, the present invention provides a fuel cell using the above electrode catalyst. Specifically, the present invention provides a solid polymer fuel cell comprising an anode, a cathode, and a polymer electrolyte membrane located between the anode and the cathode. An electrode catalyst comprises an alloy consisting of platinum and a platinum-family metal other than platinum and carried by carbon. The composition ratio of platinum to platinum-family metal other than platinum to carbon is 1:(0.03 to 1.5):(0.46 to 2.2) (wt ratio).

The fuel cell in accordance with the present invention is composed of a planar unit cell and two separators arranged on the respective sides of the unit cell. The fuel cell uses the above electrode catalyst to cause an electrode reaction shown in Formula (1) in the anode and an electrode reaction shown in Formula (2) in the cathode. As a whole, a total cell reaction shown in Formula (3) occurs to generate an electromotive force.

The electrode catalyst exhibiting both enhanced catalytic activity and high durability contributes to the improved durability and generation performance of the fuel cell in accordance with the present invention.

According to the present invention, the optimum range of composition ratio of platinum to platinum-family metal other than platinum to carbon significantly improves the initial performance and durability of the fuel cell.

### BRIEF DESCRIPTION OF THE DRAWINGS

FIG. 1 shows a cell voltage value after endurance and a cross leak amount observed with an iridium rate (=Ir/Pt [wt %]) varied; and

FIG. 2 shows an initial cell voltage value observed with a carbon rate (=C/Ir [wt %]) varied.

### BEST MODE FOR CARRYING OUT THE INVENTION

An embodiment of the present invention will be described below in detail.

A catalytic component in accordance with the present invention is an alloy consisting of platinum and a platinum-family metal other than platinum and having the following features. (1) A solid polymer fuel cell made of this alloy often has an operating temperature of at most 100° C. (2) The alloy is excellent in reaction activity and stability in spite of a strong acidity exhibited by an ion exchange resin normally contained in a catalyst layer and covering catalyst particles.

Examples of a material compound containing platinum and a platinum-family metal other than platinum include halides such as chlorides or bromides of platinum and the platinum-family metal other than platinum, alkoxides such as methoxides and ethoxides, oxides, nitrates, and sulfites; any of these various material compounds can be used to manufacture the alloy consisting of platinum and a platinum-family metal other than platinum. A preferred method for an alloying process involves thermally treating a reduced platinum component and a reduced component of platinum-family metal other than platinum at a temperature of 600 to 900° C. in an inactive gas atmosphere.

The alloy catalyst consisting of platinum and the platinum-family metal other than platinum preferably has a particle size of 3 to 20 nm in order to offer a high activity. A particle size of smaller than 3 nm allows particles to be easily aggregated, melted, or re-precipitated to grow the particles. On the other hand, a particle size of greater than 20 nm reduces the surface area of the alloy metal catalyst relative to the amount of alloy metal catalyst used. This prevents the provision of a sufficient catalyst activity. Consequently, the alloy catalyst consisting of platinum and the platinum-family metal other than platinum preferably has a particle size of 3 to 15 nm.

Carbon used as a conductive carrier may be a well-known carbon material. Preferred examples of the carbon include carbon blacks such as channel black, furnace black, thermal black, and acetylene black, and activated carbon.

When electrodes in accordance with the present invention are used for a solid polymer fuel cell, either a fluorine containing electrolyte or a hydrocarbon containing electrolyte may be used as a polymer electrolyte. The fluorine containing polymer electrolyte is a fluorine containing polymer compound into which an electrolyte group such as a sulfonic group or carboxylic group is introduced. The fluorine containing polymer electrolyte used for the fuel cell in accordance with the present invention is a polymer comprising a fluorocarbon skeleton or a hydrofluorocarbon skeleton into which an electrolytic group such as a sulfonic group is introduced as a substituent group. Molecules of the polymer may contain an ether group, a chlorine group, a carboxylic group, a phosphoric group, or an aromatic group. A polymer commonly used comprises perfluorocarbon serving as a main chain skeleton and a sulfonic group located via a spacer such as perfluoroether or an aromatic ring. Specific known examples of such a polymer include “Nafion (registered trade mark)” manufactured by Dupont and “Aciplex-S (registered trade mark)” manufactured by Asahi Kasei Corporation. The hydrocarbon containing polymer electrolyte used for the fuel cell in accordance with the present invention has a hydrocarbon part on any of the molecular chains constituting a polymer compound, and an electrolytic group introduced thereinto. Examples of the electrolytic group include a sulfonic group and a carboxylic group.

### Examples

The present invention will be described below in further detail with reference to examples and comparative examples. The examples and comparative examples use platinum-iron catalysts, but the present invention is not limited to this.

### [Manufacture of Catalyst Carrying Carbon]

### Example 1

First, 4.95 g of commercially available carbon powder of a large specific surface area was added to and dispersed in 0.5 L of pure water. A hexahydroxo platinum nitrate solution containing 4.05 g of platinum and an iridium nitrate solution containing 1.00 g of iridium were dropped into the fluid dispersion in this order. The fluid dispersion was sufficiently blended with the carbon. About 100 mL of 0.1 N ammonia was added to the fluid dispersion and the fluid dispersion is adjusted to pH of 10. Corresponding hydroxides were formed and precipitated on the carbon. The fluid dispersion was filtered, and a powder obtained was dried in a vacuum at 100° C. for 10 hours. The powder was then held in a hydrogen gas atmosphere at 400° C. for 2 hours so as to be reduced. The powder was then held in the presence of nitrogen gas at 600° C. for 2 hours so as to be alloyed.

The metal carrying densities of the platinum alloy carrying carbon powder catalyst obtained were such that the catalyst contained 40.51 wt % of platinum and 9.98 wt % of iridium. The weight ratio of the powder components, that is, the weight ratio of Pt to Ir to C, was 1:0.25:1.2. XRD measurements showed only a Pt peak, and a shift of the peak of a Pt (111) surface near 39° to a larger angle indicated the solid solution of iridium. Moreover, Pt had a lattice constant of 3.91 Å as calculated from the peak of the Pt (111) surface and a particle size of 4.2 nm as calculated from a half-value width.

Then, in Examples 2 to 4 and Comparative Examples 1 to 3, with the weight ratio of carbon to Pt was fixed to 1.2, the effects of a variation in iridium weight rate were examined with the iridium weight rate set as follows.

### Example 2

The feed amounts of carbon, platinum, and iridium were 5.33 g, 4.36 g, and 0.30 g, respectively. The product ratio of Pt to Ir to C was 1:0.08:1.2 (wt % ratio). The catalyst was prepared in the same manner as in Example 1.

### Example 3

The feed amounts of carbon, platinum, and iridium were 3.81 g, 3.12 g, and 3.07 g, respectively. The product ratio of Pt to Ir to C was 1:1:1.2 (wt % ratio). The catalyst was prepared in the same manner as in Example 1.

### Example 4

The feed amounts of carbon, platinum, and iridium were 3.30 g, 2.70 g, and 3.99 g, respectively. The product ratio of Pt to Ir to C was 1:1.5:1.2 (wt % ratio). The catalyst was prepared in the same manner as in Example 1.

### Comparative Example 1

The feed amounts of carbon, platinum, and iridium were 5.43 g, 4.44 g, and 0.13 g, respectively. The product ratio of Pt to Ir to C was 1:0.03:1.2 (wt % ratio). The catalyst was prepared in the same manner as in Example 1.

### Comparative Example 2

The feed amounts of carbon, platinum, and iridium were 2.92 g, 2.39 g, and 4.70 g, respectively. The product ratio of Pt to Ir to C was 1:2:1.2 (wt % ratio). The catalyst was prepared in the same manner as in Example 1.

### Comparative Example 3

The feed amounts of carbon, platinum, and iridium were 5.55 g, 4.50 g, and 0.00 g, respectively. The product ratio of Pt to Ir to C was 1:0:1.2 (wt % ratio). The catalyst was prepared in the same manner as in Example 1.

Then, in Examples 5 to 7 and Comparative Examples 4 and 5, with the weight ratio of iridium to Pt fixed to 0.25, the effects of a variation in carbon weight rate were examined with the carbon weight rate set as follows.

### Example 5

The feed amounts of carbon, platinum, and iridium were 6.33 g, 2.90 g, and 0.71 g, respectively. The product ratio of Pt to Ir to C was 1:0.25:2.2 (wt % ratio). The catalyst was prepared in the same manner as in Example 1.

### Example 6

The feed amounts of carbon, platinum, and iridium were 5.01 g, 4.01 g, and 0.99 g, respectively. The product ratio of Pt to Ir to C was 1:0.25:1.25 (wt % ratio). The catalyst was prepared in the same manner as in Example 1.

### Example 7

The feed amounts of carbon, platinum, and iridium were 2.70 g, 5.86 g, and 1.44 g, respectively. The product ratio of Pt to Ir to C was 1:0.25:0.46 (wt % ratio). The catalyst was prepared in the same manner as in Example 1.

### Comparative Example 4

The feed amounts of carbon, platinum, and iridium were 7.27 g, 2.19 g, and 0.54 g, respectively. The product ratio of Pt to Ir to C was 1:0.25:3.3 (wt % ratio). The catalyst was prepared in the same manner as in Example 1.

### Comparative Example 5

The feed amounts of carbon, platinum, and iridium were 1.88 g, 6.52 g, and 1.61 g, respectively. The product ratio of Pt to Ir to C was 1:0.25:0.20 (wt % ratio). The catalyst was prepared in the same manner as in Example 1.

### Referential Example

A platinum-cobalt alloy catalyst was prepared for a comparison with the conventional art. A hexahydroxo platinum nitrate solution containing 3.17 g of platinum and a cobalt nitrate solution containing 0.29 g of cobalt were used. The remaining part of the method for preparing a catalyst was the same as that in Example 1.

The catalysts obtained in the above examples and comparative examples were checked for their initial performance and durability as methods described below.

### [Initial Voltage Measurements]

To compare catalyst performance in an initial stage, initial voltage was measured by the method of initial voltage measurement. According to this measurement method, unit temperature was set to 80° C., and the cathode was supplied with humidified air passed through a bubbler heated to 50° C., in a stoichiometric mixture ratio of 2.5. The anode was supplied with humidified air passed through the bubbler heated to 60° C., in a stoichiometric mixture ratio of 2 and current and voltage characteristics were measured. The performance of each catalyst was measured until current and voltage were stabilized. The performance was compared at a voltage value at a current density of 0.1 A/cm².

### [Endurance Conditions]

After the initial voltage measurements, endurance tests were conducted under the following conditions. The unit temperature was set to 80° C., and the cathode was supplied with humidified air passed through a bubbler heated to 80° C., in a stoichiometric mixture ratio of 2.5. The anode was supplied with humidified air passed through the bubbler heated to 55° C., in a stoichiometric mixture ratio of 2. The current value was varied every five seconds at 0 CV and 0.7 A/cm². One thousand hours later, the method of initial voltage measurement was carried out to measure the voltage value at 0.1 A/cm² to compare endurance performance.

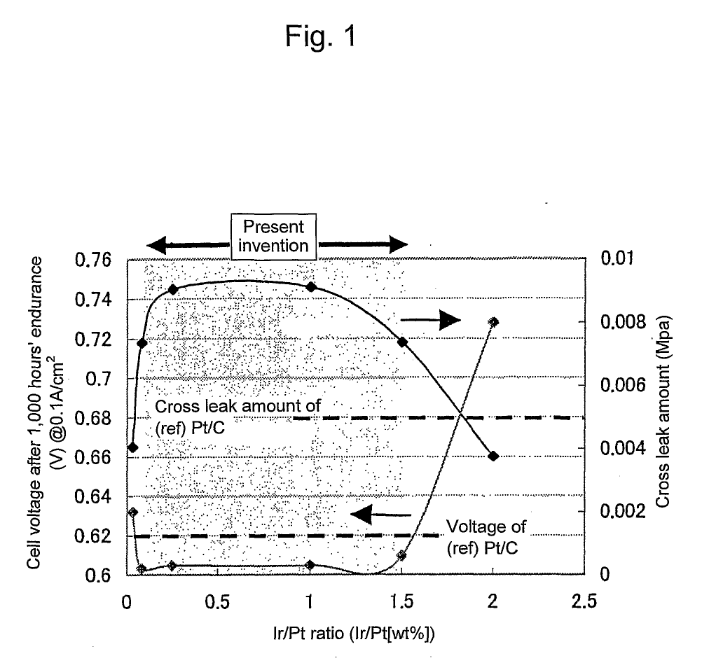

Table 1 shows the physical property values of each catalyst, the cell voltage value after endurance, and the amount of cross leak observed with the iridium ratio (=Ir/Pt [wt %]) varied. FIG. 1 shows a comparison of the cell voltage value after endurance and the amount of cross leak observed with the iridium ratio (=Ir/Pt [wt %]) varied.

TABLE 1

| | | | | | | | | Cell voltage after | |
|---|---|---|---|---|---|---|---|---|---|
| | | | | | Catalyst | Lattice | Initial cell voltage | endurance | Cross leak |
| | Weight ratio [wt %] | | | Ir/Pt | particle size | constant | @0.1 A/cm² | @0.1 A/cm² | amount |
| | Pt | Ir | C | [wt %] | [nm] | [Å] | [V] | [V] | [MPa] |
| Comparative | 1 | 0.03 | 1.2 | 0.03 | 3.9 | 3.919 | 0.735 | 0.665 | 0.002 |
| Example 1 | | | | | | | | | |
| Example 2 | 1 | 0.08 | 1.2 | 0.08 | 4.1 | 3.916 | 0.761 | 0.718 | 0.0002 |
| Example 1 | 1 | 0.25 | 1.2 | 0.25 | 4.2 | 3.906 | 0.786 | 0.745 | 0.0003 |
| Example 3 | 1 | 1 | 1.2 | 1 | 3.8 | 3.883 | 0.784 | 0.746 | 0.0003 |
| Example 4 | 1 | 1.5 | 1.2 | 1.5 | 4.1 | 3.875 | 0.767 | 0.718 | 0.0006 |
| Comparative | 1 | 2 | 1.2 | 2 | 4.2 | 3.870 | 0.745 | 0.660 | 0.006 |
| Example 2 | | | | | | | | | |
| Comparative | 1 | 0 | 1.2 | 0 | 3.2 | 3.923 | 0.730 | 0.620 | 0.0005 |
| Example 3 | | | | | | | | | |
| Referential | 1 | — | 1.2 | — | 4.2 | 3.876 | 0.787 | 0.743 | 0.0003 |
| Example | | | | | | | | | |

The results in Table 1 indicate that alloying Pt and Ir improved the initial performance, which had its maximum value when Pt:Ir=1:0.25. For the endurance performance, at an Ir rate (=Ir/Pt [wt %]) of 0.08 to 1.5, the voltage drop was small even after 1,000 hours' operation; the voltage was equal to or greater than the after-endurance target value. In particular, at an Ir rate of 0.16 to 1.25, high endurance performance was exhibited even after 1,000 hours' operation. The cross leak amount increased rapidly after the Ir rate exceeded 1.5. It is expected that an increase in Ir rate increases the amount of hydrogen peroxide generated to promote degradation of the electrolyte membrane.

Table 1 shows a referential example for an alloy catalyst other than PtIr. The PtCo catalyst exhibited an initial voltage value almost similar to that of PtIr but a very significant voltage drop after endurance. This is expected to be because a voltage variation resulting from endurance promoted the separation of Pt from Co to degrade the catalytic activity and because the elution of Co degraded the electrolyte membrane.

As is apparent from the above description, in spite of its high initial catalytic performance, the PtIr catalyst exhibits a high endurance voltage drop rate at a high Ir rate owing to generated hydrogen peroxide. Thus, when the ratio of Pt to Ir is 1:0.08 to 1.5 (Ir/Pt [wt %]), the PtIr catalyst exhibits a high initial performance and a low endurance voltage drop rate. The PtIr catalyst is thus expected to be excellent.

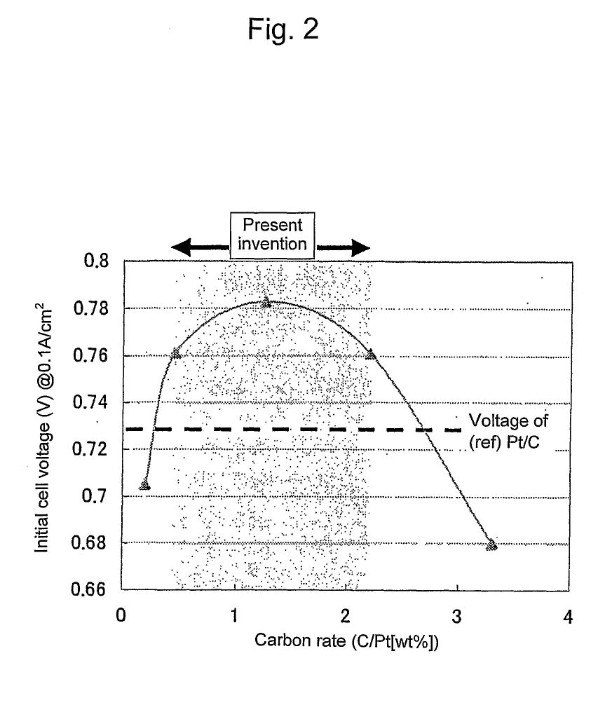

Then, Table 2 shows the catalyst physical property values obtained with the carbon rate (=C/Ir [wt %]) varied. FIG. 2 shows the initial cell voltage value obtained with the carbon rate (=C/Ir [wt %]) varied.

TABLE 2

| | | | | Catalyst | | Initial cell |
|---|---|---|---|---|---|---|
| | | | | particle | Lattice | voltage |
| | Weight ratio [wt %] | | | size | constant | @0.1 A/cm² |
| | Pt | Ir | C | [nm] | [Å] | [V] |
| Comparative | 1 | 0.25 | 0.2 | 5.5 | 3.906 | 0.705 |
| Example 5 | | | | | | |
| Example 7 | 1 | 0.25 | 0.46 | 4.3 | 3.906 | 0.761 |
| Example 6 | 1 | 0.25 | 1.25 | 4.3 | 3.906 | 0.783 |
| Example 5 | 1 | 0.25 | 2.2 | 4.3 | 3.906 | 0.761 |
| Comparative | 1 | 0.25 | 3.3 | 4.3 | 3.906 | 0.68 |
| Example 4 | | | | | | |

The results in Table 2 indicate that the cell voltage started to increase rapidly at a carbon rate of 0.46 and that the cell voltage remained equal to or greater than the target value until the carbon rate reached 2.2; the catalysts exhibited a high initial performance. The cell voltage decreased rapidly after the carbon rate exceeded 2.2. This is due to a low metal carrying density. At a carbon rate of less than 0.46, metal particles are aggregated because of the reduced amount of carbon, serving as a carrier. This drastically reduces the effective reaction rate of PtIr and degrades performance.

As is apparent from the above description, the Par catalyst exhibits a high initial performance and is very durable but significantly affects not only the rates of Pt and Ir but also the amount of carbon, serving as a carrier. Consequently, when the composition ratio of Pt to Ir to C is 1:0.08 to 1.5:0.46 to 2.2, the PtIr catalyst exhibits an excellent initial performance and a high durability.

An alloy of platinum and a platinum-family metal other than platinum also exhibited results similar to those shown in Tables 1 and 2 and FIGS. 1 and 2. For example, with rhodium (Rh) used as the platinum-family metal other than platinum, the PtRh catalyst exhibited a high initial performance and a low endurance voltage drop rate when the composition ratio of platinum to rhodium to carbon was in the range of 1:(0.03 to 1.5):(0.46 to 2.2) (wt ratio). Further, with gold (Au) used as the platinum-family metal other than platinum, the PtAu catalyst exhibited a high initial performance and a low endurance voltage drop rate when the composition ratio of platinum to gold to carbon was in the range of 1:(0.03 to 1.5):(0.46 to 2.2) (wt ratio).

### INDUSTRIAL APPLICABILITY

The present invention uses the optimum range of composition ratio of platinum to platinum-family metal other than platinum to carbon to inhibit the degradation of initial performance of the fuel cell, while significantly improving its durability. This contributes to the practical application and prevalence of the fuel cell.

1. A fuel cell electrode catalyst having an alloy carried by carbon, the alloy consisting of a platinum and platinum-family metal other than platinum, characterized in that a composition ratio of platinum to platinum-family metal other than platinum to carbon is 1:(0.03 to 1.5):(0.46 to 2.2) (wt ratio).

2. The fuel cell electrode catalyst according to claim 1, characterized in that the platinum-family metal other than platinum is iridium (Ir), and the composition ratio of platinum to iridium to carbon is 1:(0.08 to 1.5):(0.46 to 2.2) (wt ratio).

3. The fuel cell electrode catalyst according to claim 2, characterized in that a platinum (111) surface has a lattice constant of 3.875 to 3.916 Å as calculated from X ray diffraction results.

4. The fuel cell electrode catalyst according to claim 1, characterized in that the platinum-family metal other than platinum is rhodium (Rh), and the composition ratio of platinum to rhodium to carbon is 1:(0.03 to 1.5):(0.46 to 2.2) (wt ratio).

5. The fuel cell electrode catalyst according to claim 1, characterized in that the platinum-family metal other than platinum is gold (Au), and the composition ratio of platinum to gold to carbon is 1:(0.03 to 1.5):(0.46 to 2.2) (wt ratio).

6. The fuel cell electrode catalyst according to any of claims 1 to 5, characterized in that the alloy consisting of the platinum and the platinum-family metal other than platinum have an average particle size of 3 to 20 nm.

7. A method for manufacturing a fuel cell electrode catalyst having platinum or an alloy carried by carbon, the alloy consisting of platinum and a platinum-family metal other than platinum, wherein a composition ratio of platinum to platinum-family metal other than platinum to carbon is 1:(0.03 to 1.5):(0.46 to 2.2) (wt ratio), characterized by a step of adding palatinate and a salt of platinum-family metal salt other than platinum to a water dispersion of carbon, a step of converting the palatinate and the salt of platinum-family metal other than platinum into hydroxides in an alkali atmosphere, a step of reducing the hydroxide of the platinum and the hydroxide of the platinum-family metal other than platinum, and a step of alloying the reduced platinum and the reduced platinum-family metal other than platinum.

8. The method for manufacturing a fuel cell electrode catalyst according to claim 7, characterized in that the platinum-family metal other than platinum is iridium (Ir), and the composition ratio of platinum to iridium to carbon is 1:(0.08 to 1.5):(0.46 to 2.2) (wt ratio).

9. The method for manufacturing a fuel cell electrode catalyst according to claim 8, characterized in that a platinum (111) surface has a lattice constant of 3.875 to 3.916 Å as calculated from X ray diffraction results.

10. The method for manufacturing a fuel cell electrode catalyst according to claim 7, characterized in that the platinum-family metal other than platinum is rhodium (Rh), and the composition ratio of platinum to rhodium to carbon is 1:(0.03 to 1.5):(0.46 to 2.2) (wt ratio).

11. The method for manufacturing a fuel cell electrode catalyst according to claim 7, characterized in that the platinum-family metal other than platinum is gold (Au), and the composition ratio of platinum to gold to carbon is 1:(0.03 to 1.5):(0.46 to 2.2) (wt ratio).

12. The method for manufacturing a fuel cell electrode catalyst according to any of claims 7 to 11, characterized in that the alloy consisting of the platinum and the platinum-family metal other than platinum have an average particle size of 3 to 20 nm.

13. A fuel cell using the electrode catalyst according to any of claims 1 to 6.
